(19) United States
(12) Patent Application Publication
(10) Pub. No.: US 2004/0057346 A1
(43) Pub. Date: Mar. 25, 2004

(54) Apparatus and methods for cartridge retrieval and insertion in a storage library system

(76) Inventor: Alan Dean Romig, Flint, MI (US)

Correspondence Address: DUFT SETTER OLLILA & BORNSEN LLC, 2060 BROADWAY, SUITE 300, BOULDER, CO, 80302, US

(21) Appl. No.: 10/255,021

(22) Filed: Sep. 25, 2002

(51) Int. Cl. G11B 7/085

(52) U.S. Cl. 369/30.32

(57) ABSTRACT

A storage library system maximizes use of storage space and minimizes mechanical misalignment. The storage library system has a plurality of storage media ports, a robotic shuttle, and a storage media transport. The robotic shuttle physically accesses the storage media cartridges as it linearly moves along the storage media ports. The storage media transport transports the storage media cartridges between an access port and a position adjacent to the storage media ports. The storage media cartridges are moved in first and second substantially orthogonal directions that allow substantially unrestricted access of the storage media cartridges stored in the storage media ports by the robotic shuttle. The robotic shuttle may also access the storage media cartridges transported by the storage media transport. This operation provides a highly compact storage library system that can easily and comfortably fit on a desktop.

### BACKGROUND OF THE INVENTION

1. Field of the Invention

The present invention relates to storage library systems as commonly used in computer data storage. More specifically, the present invention relates to an apparatus and associated methods for robotic access of storage media cartridges in a storage library system.

2. Discussion of Related Art

Storage library systems provide large capacity secondary storage to modern computing environments with storage media cartridges. Such storage library systems typically employ robotic control mechanisms to physically manage the storage media cartridges used by host computer systems. The storage media cartridges are stored within the storage library system. Each storage media cartridge is stored in a particular port of the storage library system. Each port is identifiable by its physical position in the storage library system and each cartridge is uniquely identified by a machine-readable label. The storage library system maintains inventory information to associate a particular cartridge with a particular port in the storage library system.

Responsive to a host computer system request, a storage media cartridge is physically retrieved from its associated port with a robotic mechanism. The storage media cartridge is then moved to a read/write device for processing. Conversely, when processing of the storage media cartridge is complete, the cartridge is retrieved by the robotic mechanism from the read/write device, moved to its associated port, and reinserted into the associated port for future use.

Computing environments have become smaller and less centralized than those of the past. Prior storage library systems were often costly, excessively large, and difficult to use. While arguably appropriate for centralized large data processing environments, prior storage library systems are inappropriate in the more modern and decentralized workstation environments. In these environments, reduced costs, complexity, and size of storage library systems are essential features.

Prior storage library systems were often configured with storage media cartridge ports arranged in circular or cylindrical arrays and wasted valuable space. Furthermore, the prior storage library systems introduced mechanical complexities commonly associated with achieving accurate and repeatable curvilinear motion. Complex rotating robotic arms and robotic cartridge hands or grippers were the norm in these devices.

Mechanical problems arise in storage library systems that robotically access storage media cartridges from associated ports. For example, if the robotic mechanism misaligns a storage media cartridge while inserting it into a port, the robotic mechanism may not properly insert the cartridge into the port and may damage the cartridge and/or the port. In larger storage library systems, common to prior designs, the frequency of such problems can be minimized by precise manufacturing tolerances. Such precise manufacturing tolerances add cost and complexity to the storage library system.

To increase overall storage capacity without increasing physical size of the storage library system, removable storage holders, or magazines, are used such that a plurality of storage media cartridges are held. The removable storage holders increase the overall storage capacity by permitting the user to store additional magazines of storage media cartridges external to the storage library system. When an externally stored magazine is needed, the user removes one magazine from the storage library system and substitutes it with a desired magazine.

Constant removal and substitution of the magazines tends to exacerbate the mechanical tolerance problems identified above. A magazine manually inserted into the storage library system may be misaligned from a nominal position. This skewed position may cause additional misalignment of the robotic mechanisms. Though this misalignment may be reduced by mechanical components that improve alignment, such mechanisms increase costs and complexity of the storage library system.

One approach to resolving some of above-mentioned problems consists of physically sensing precise physical positions of each port or magazine to adjust the robotic mechanism for proper alignment to each port or magazine. Physical sensing is either mechanically or optically performed. Such a solution dramatically increases costs and complexities of the storage library system.

Other approaches include implementations of an access port. The implementations of the access port attempt to address the user's physical access of the storage media cartridges. The access port allows the user to insert and extract the storage media cartridges from the storage library system without manually intervening with the internal components of the storage library system. However, transporting the storage media cartridges to and from the access port is continually problematic.

As evident from the above discussion, a need exists for improved structures and methods to maximize use of valuable storage space and to minimize mechanical misalignments. SUMMARY OF THE INVENTION

The present invention solves the above problems and thereby advances the art by providing simpler apparatus and corresponding methods to maximize use of valuable storage space and to minimize mechanical misalignments. The present invention comprises a storage library system having a plurality of storage media ports configured for storing storage media cartridges. In one aspect of the invention, the storage media cartridges are physically accessed with a robotic shuttle that linearly moves along the storage media ports. In another aspect of the invention, a storage media transport transports the storage media cartridges between an access port and a position adjacent to the storage media ports. The storage media transport may move a storage media cartridge in first and second substantially orthogonal directions while allowing relatively unrestricted access of the storage media cartridges by the robotic shuttle. This operation provides a highly compact storage library system that can easily and comfortably fit on a desktop.

The robotic shuttle is capable of manipulating the storage media cartridges by accepting a storage media cartridge of one port and passing the storage media cartridge to another port, holding the storage media cartridge secure in the interim. In a preferred embodiment, the robotic shuttle is thus capable of retrieving storage media cartridges from, or feeding storage media cartridges to, a media read-write device and/or the access port. To perform the manipulation operations mentioned, the robotic shuttle may include a robotic gripper to hold the storage media cartridges. Additionally, the storage media transport may include a means for retaining the storage media cartridges during transport between the access port and the position adjacent to the ports. An example of such may include a passive latch.

In a preferred embodiment of the invention, the storage media transport includes a carriage and a transport mechanism for moving the carriage between the access port and the position adjacent to the storage media ports.

In one aspect of the invention, a storage library system has a frame and an access port for operator access to storage media cartridges. The storage library system includes a plurality of ports attached to the frame, each of the ports configured for storing at least one of the storage media cartridges. The storage library system also includes a robotic shuttle moveably attached to the frame for linearly moving along the plurality of the ports to physically access the plurality of the ports. The storage library system also includes a storage media transport moveably attached to the frame for transporting the storage media cartridges between the access port and a position adjacent to the plurality of the ports, wherein transporting the storage media cartridges includes movement in first and second substantially orthogonal directions.

In another aspect of the invention, the storage library system further includes a read/write device to communicatively access the storage media cartridges.

In another aspect of the invention, the robotic shuttle includes a robotic gripper to manipulate the storage media cartridges between the robotic shuttle and the plurality of the ports.

In another aspect of the invention, the storage media transport includes a carriage and a transport mechanism for moving the carriage between the access port and the position adjacent to the plurality of the ports while allowing substantially unrestricted motion of the robotic shuttle.

In another aspect of the invention, the carriage includes a plurality of wheels and a clamp connected to the transport mechanism to enable movement of the carriage. The carriage may also include a camming mechanism for adjusting a storage media cartridge transport tray to the position adjacent to the plurality of the ports.

In another aspect of the invention, the transport mechanism includes a ramp attached to the frame for adjusting the position of the storage media cartridge transport tray with the camming mechanism when the camming mechanism contacts the ramp.

In another aspect of the invention, the storage media cartridge transport tray includes a means for securing the transport tray as the transport tray approaches the position adjacent to the plurality of the ports.

In another aspect of the invention, the transport mechanism includes a motor having a driveshaft with an attached pulley, a track configured for guiding the plurality of the wheels, and a belt system connected to the pulley of the motor for moving the carriage along the track as the driveshaft turns.

In another aspect of the invention, the belt system includes a pulley attached to the track such that the belt system wraps around the two pulleys, wherein a turn of the driveshaft actuates motion of the carriage in a direction towards the access port and an opposite turn of the driveshaft actuates motion of the carriage in a direction towards the position adjacent to the plurality of the ports.

In one aspect of the invention, a method provides for controllably operating a storage library system to access storage media cartridges. The method includes steps of shuttling at least one of the storage media cartridges between a plurality of ports in a first linear manner and transporting the storage media cartridges between an access port and a position adjacent to the plurality of the ports, wherein transporting the storage media cartridges includes movement in first and second substantially orthogonal directions while allowing substantially unrestricted shuttling.

In another aspect of the invention, the step of shuttling includes steps of retrieving the storage media cartridges from the plurality of the ports to a read/write device and placing the storage media cartridges in the plurality of the ports when ejected from the read/write device. The step of shuttling may also include a step of processing one or more signals to initiate the steps of retrieving and placing.

In another aspect of the invention, the method includes a step of communicatively accessing the storage media cartridges with the read/write device.

In another aspect of the invention, the step of transporting includes steps of retrieving the storage media cartridges from the access port; and ejecting the storage media cartridges through the access port.

In another aspect of the invention, the step of retrieving includes a step of sensing a presence of one or more of the storage media cartridges in the access port. The step of retrieving may also include a step of processing a signal to retrieve the storage media cartridges from the access port in response to sensing the presence.

In another aspect of the invention, the step of ejecting includes a step of processing a signal to eject the storage media cartridges through the access port.

Advantages of the invention include a compact storage library system that shuttles storage media cartridges between the storage media ports and transports the storage media cartridges between an access port and a position adjacent to the storage media ports. Other advantages include a substantially unrestricted shuttling due to the method of transporting.

### BRIEF DESCRIPTION OF THE PREFERRED EMBODIMENTS

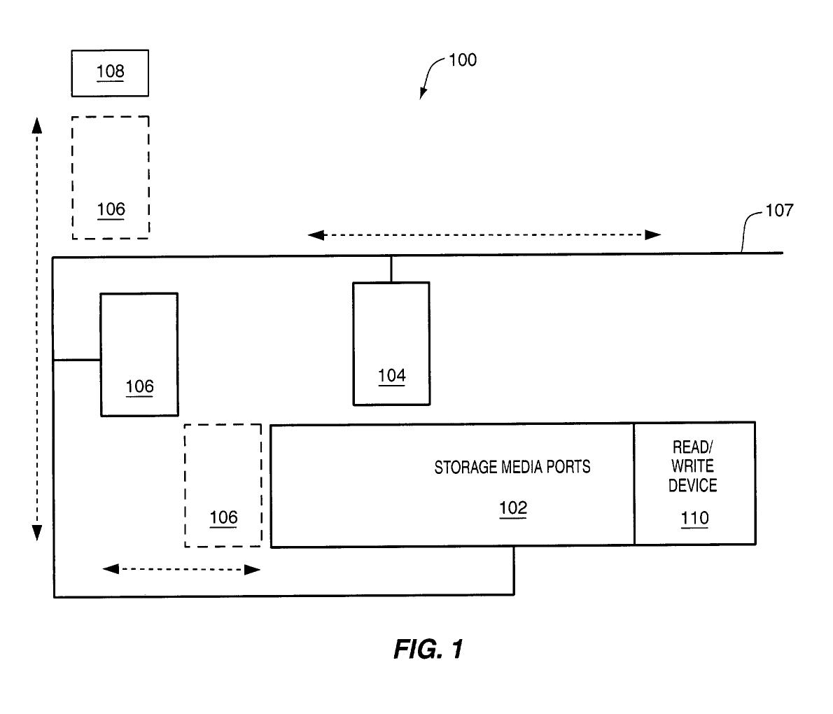

FIG. 1 is a block diagram illustrating an exemplary preferred embodiment of the invention.

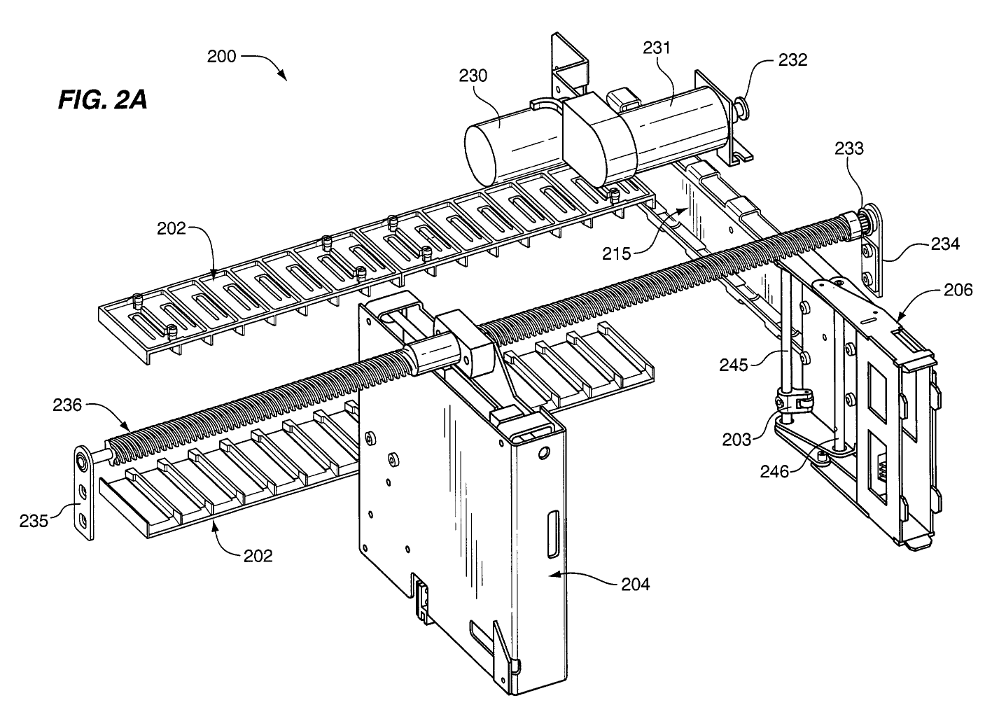

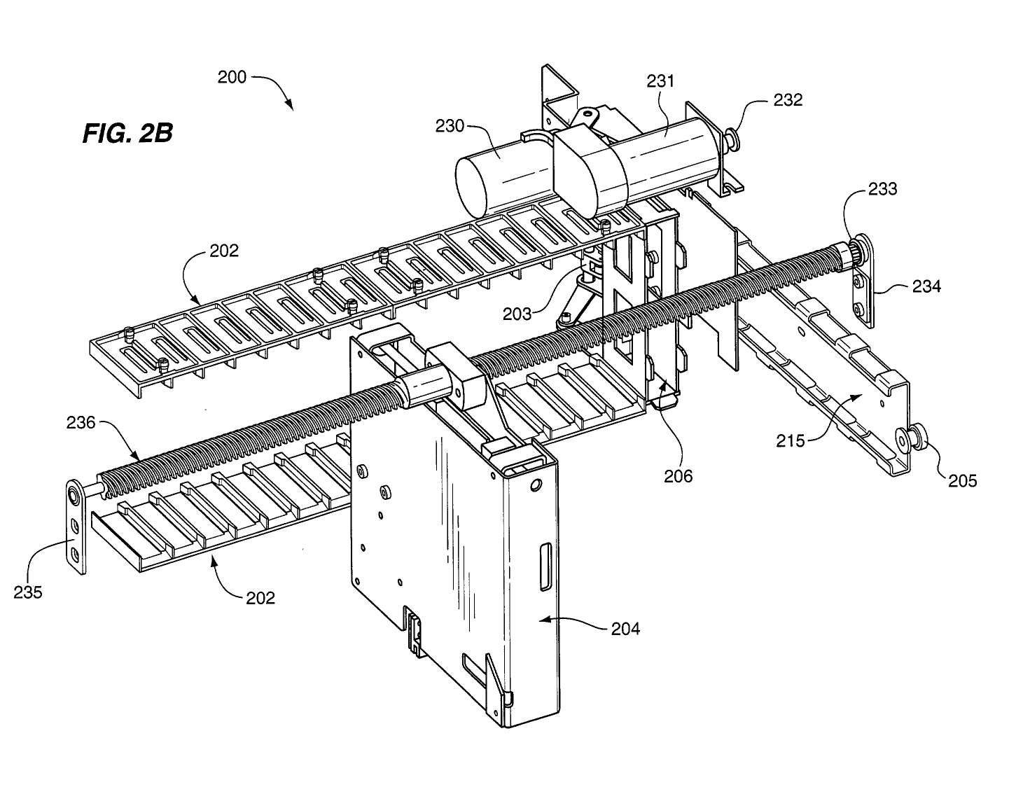

FIG. 2A shows an isometric view illustrating an exemplary preferred embodiment of the invention in one position.

FIG. 2B shows another isometric view illustrating the exemplary preferred embodiment of the invention in another position.

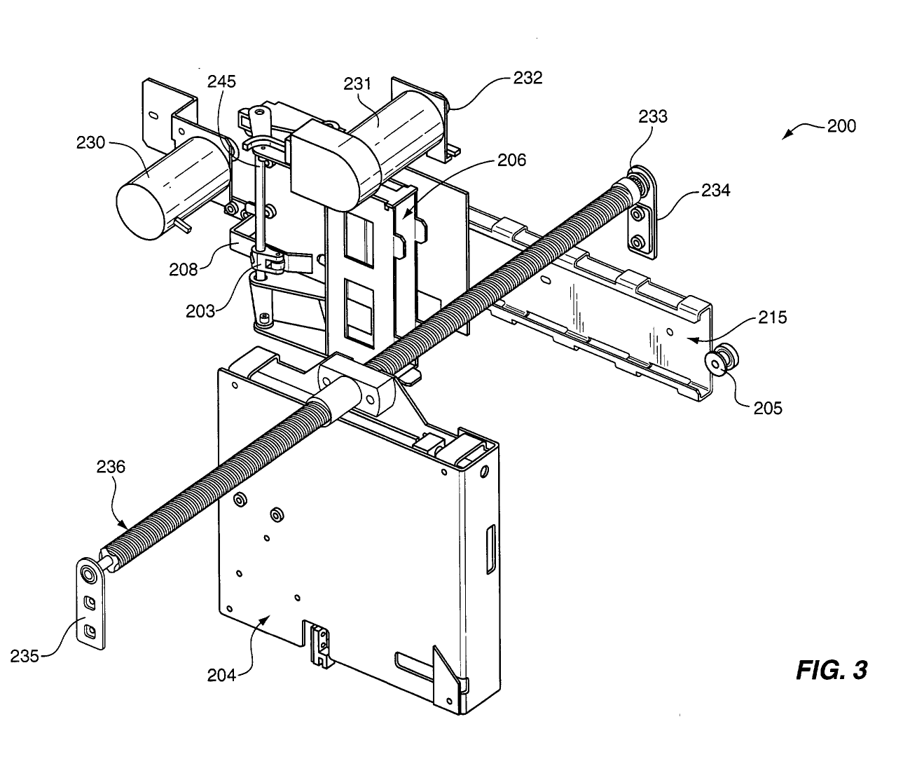

FIG. 3 shows an isometric exposed view illustrating the exemplary preferred embodiment of the invention.

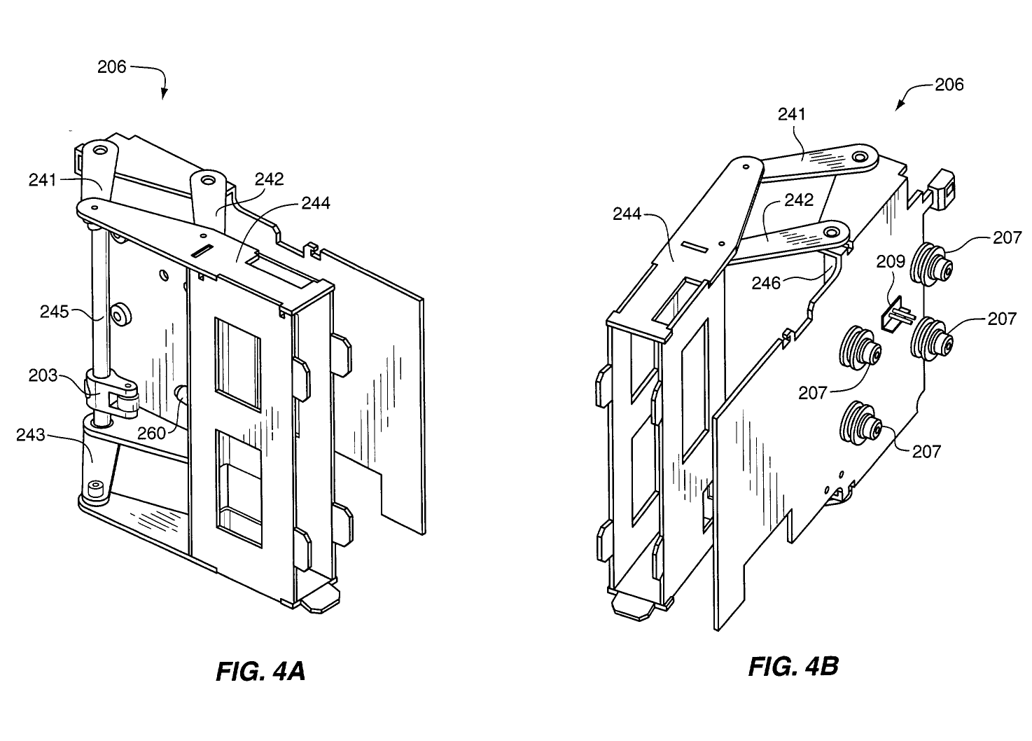

FIG. 4A shows an isometric view illustrating a storage media transport of the exemplary preferred embodiment of the invention.

FIG. 4B shows another isometric view illustrating the storage media transport of the exemplary preferred embodiment of the invention.

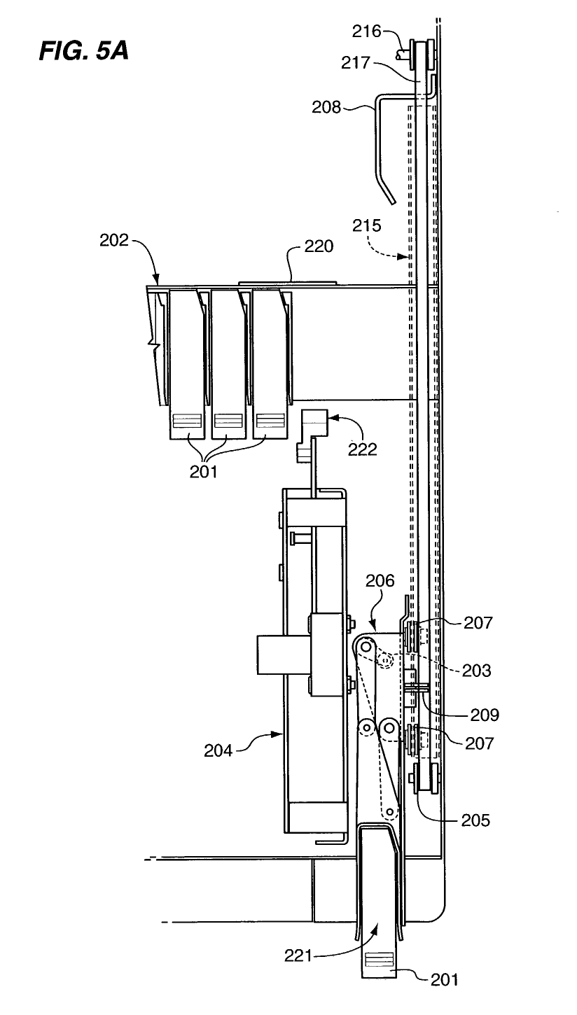

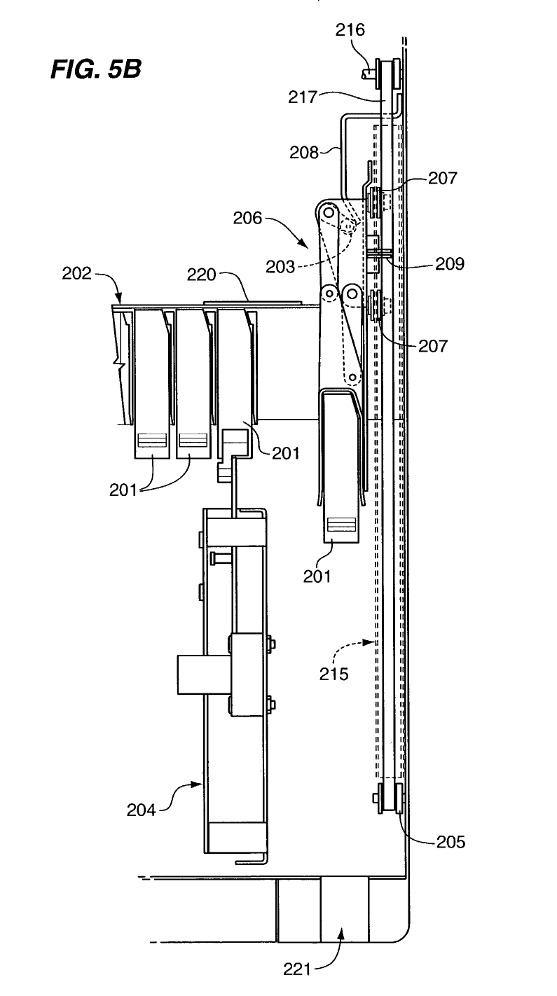

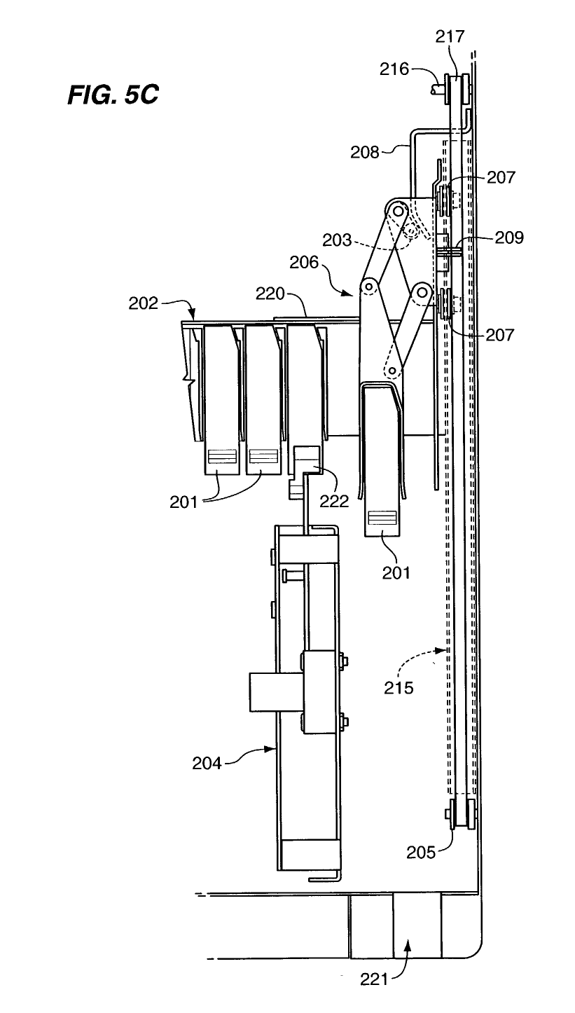

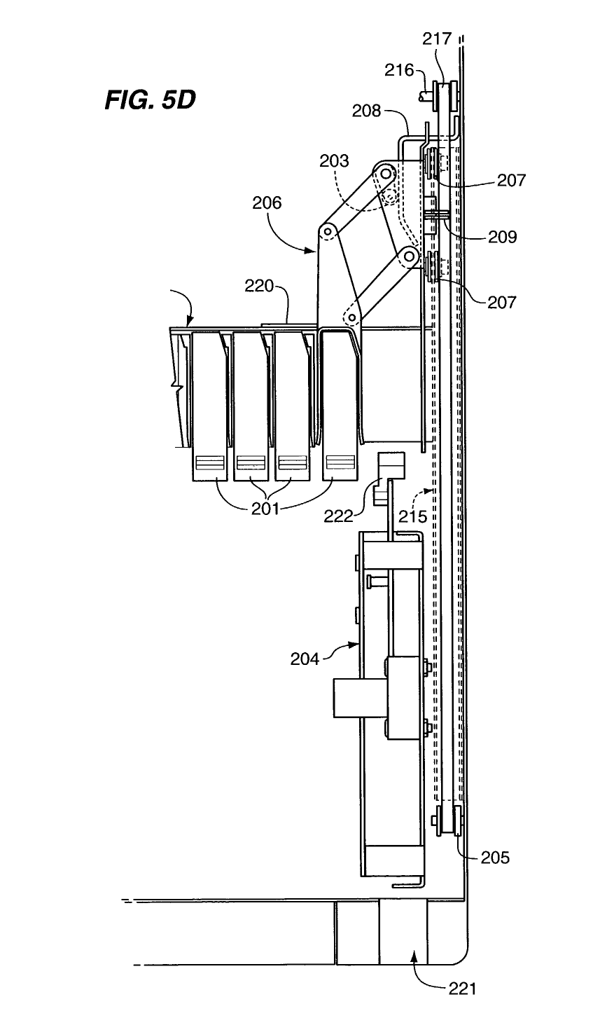

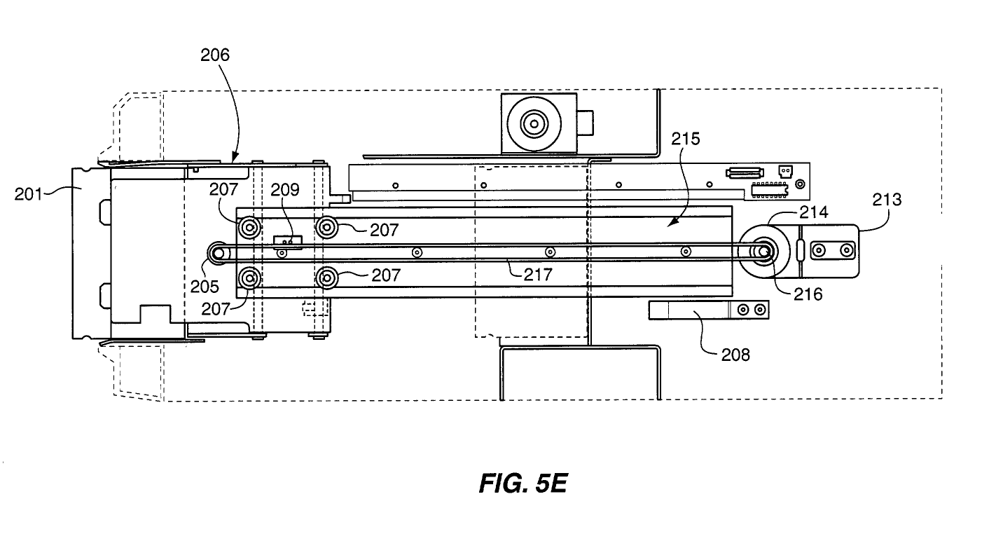

FIG. 5A shows a perspective view illustrating a first position of the storage media transport of the exemplary preferred embodiment of the invention.

FIG. 5B shows a perspective view illustrating a second position of the storage media transport of the exemplary preferred embodiment of the invention.

FIG. 5C shows a perspective view illustrating a third position of the storage media transport of the exemplary preferred embodiment of the invention.

FIG. 5D shows a perspective view illustrating a fourth position of the storage media transport of the exemplary preferred embodiment of the invention.

FIG. 5E shows an alternative view illustrating the first position of the storage media transport of the exemplary preferred embodiment of the invention.

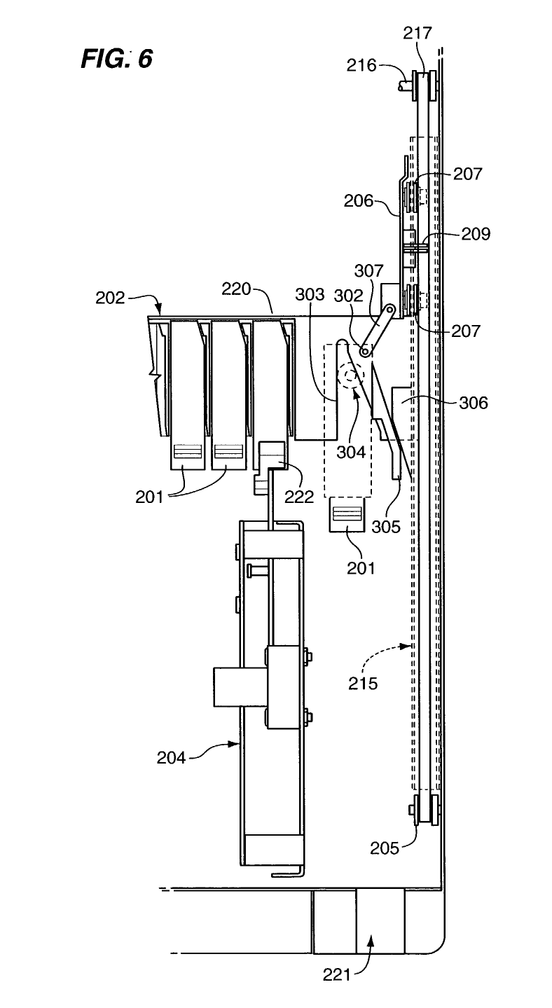

FIG. 6 shows a perspective view illustrating the third position of the storage media transport of another exemplary preferred embodiment of the invention.

### DETAILED DESCRIPTION OF THE PREFERRED EMBODIMENTS

While the invention is susceptible to various modifications and alternative forms, a specific embodiment thereof has been shown by way of example in the drawings and will herein be described in detail. Those skilled in the art will appreciate that the features described below can be combined in various ways to form multiple variations of the invention. As a result, the invention is not limited to the specific examples described below, but only by the claims and their equivalents.

With reference now to the figures and in particular with reference to FIG. 1, an exemplary preferred embodiment of the invention is shown in storage library system 100. Storage library system 100 includes storage media ports 102, robotic shuttle 104, and storage media transport 106. In storage library system 100, storage media ports 102 are attached to frame 107 and configured for storing storage media cartridges. Each of ports 102 may be configured for storing a storage media cartridge. An example of a storage media cartridge may include a tape storage media cartridge.

In storage library system 100, robotic shuttle 104 is moveably attached to frame 107 for linearly moving along storage media ports 102 and physically accessing the storage media cartridge(s) stored within. One of the storage media ports may be used as read/write device 110. Read/write device 110 may access information on a storage media cartridge for reading and writing purposes when robotic shuttle 104 inserts the storage media cartridge into the read/write device. Motion of robotic shuttle 104 along storage media ports 102 may include a substantially linear movement that is relatively to storage media ports 102. Robotic shuttle 104 may include a robotic gripper, discussed below in FIGS. 5A-5E, for retrieving the storage media cartridges from storage media ports 102 and/or for inserting the storage media cartridges to storage media ports 102.

Robotic shuttle 104 may include a storage media cartridge detector, such as a bar-code scanner, for detecting which storage media cartridge within storage media ports 102 is to be accessed. For example, robotic shuttle 104 may move along storage media ports 102 to access a storage media cartridge. Each storage media cartridge may have an attached bar-code label that is read by the bar-code scanner of robotic shuttle 104. Once a determination is made by storage library system 100 as to which storage media cartridge is to be accessed, robotic shuttle 104 may retrieve a particular storage media cartridge from an appropriate port of storage media ports 102. Similarly, robotic shuttle 104 may insert the particular storage media cartridge in the appropriate port when storage library system 100 has completed processing, at least temporarily, the particular storage media cartridge.

In storage library system 100, storage media transport 106 is moveably attached to frame 107 for transporting and holding the storage media cartridges between access port 108 and a position adjacent to storage media ports 102. Storage media transport 106 may incorporate a passive latch to retain a storage media cartridge during transport.

Storage media transport 106 may transport the storage media cartridges between first and second substantially orthogonal directions. For example, storage media transport 106 may retrieve a storage media cartridge from access port 108 and transport the storage media cartridge in a first motion that is substantially orthogonal to the motion of robotic shuttle 104. As storage media transport 106 approaches storage media ports 102, storage media transport 106 may transport the storage media cartridge in a second motion that is substantially parallel to the motion of robotic shuttle 104. The first and second motions of storage media transport 106, while substantially orthogonal, may include a curvilinear motion influenced by a camming mechanism, described in the figures below. Thus, storage media transport 106 transports the storage media cartridge between access port 108 and a position that is approximately adjacent to storage media ports 102.

Once storage media transport 106 transports the storage media cartridge from access port 108 to the position adjacent to storage media ports 102, robotic shuttle 104 may access the storage media cartridge from storage media transport 106. Similarly storage media transport 106 may receive the storage media cartridge from robotic shuttle 104 upon ejection from storage library system 100. The curvilinear motion of storage media transport 106 may prevent interference with robotic shuttle 104. One of ordinary skill in the art will readily recognize several equivalent mechanical configurations and control apparatus to provide the controlled motions of storage media transport 106 and robotic shuttle 104.

FIGS. 2A and 2B show isometric views illustrating an exemplary preferred embodiment of the invention in storage library system 200. Storage library system includes storage media ports 202, robotic shuttle 204, and storage media transport 206. In storage library system 200, storage media ports 202 are configured for storing storage media cartridges. In storage library system 200, robotic shuttle 204 is configured for moving along storage media ports 202 to physically access the storage media cartridges from storage media ports 202. In storage library system 200, storage media transport 206 is configured for transporting a storage media cartridge between an access port, such as access port 108 of FIG. 1, and a position adjacent to storage media ports 202.

In storage library system 200, robotic shuttle 204 includes screw mechanism 236, motor 231, and mounting brackets 234 and 235. Motor 231 may include a drive shaft with an attached pulley 232 for rotating a belt (not shown) around gear 233 physically connected to screw mechanism 236. As motor 231 rotates pulley 232 and turns the belt about gear 233, screw mechanism 236 may rotate and actuate substantially linear motion of robotic shuttle 204 along storage media ports 202, thereby allowing robotic shuttle 204 to physically access the storage media cartridges of storage media ports 202. Screw mechanism 236 may be mounted to a frame, such as frame 107 of FIG. 1, using mounting brackets 234 and 235. Motor 231 may be electronically controlled by a microprocessor (not shown) through software instructions. The belt, although not shown, may include “teeth” for gripping pulley 232 and gear 233. Those skilled in the art understand that other types of belts, gears, pulleys, and driveshafts may be used. Those skilled in the art understand that pulleys may also be used with or in place of gear 233, the belt, and pulley 232. Those skilled in the art understand microprocessors and software instructions. Those skilled in the art will readily appreciate that other methods of controlling motor 231 may be used.

In storage library system 200, motor 230 may rotate driveshaft 216 (viewable in FIGS. 5A-5E and 6) to turn belt 217 (viewable in FIGS. 5A-5E and 6) about gear 205 (viewable in FIGS. 2B, 3, 5A-5E, and 6). As motor 230 rotates driveshaft 216, it actuates substantially linear motion of storage media transport 206 along track 215. Storage media transport 206 may have belt clamp 209 (viewable in FIGS. 4B, 5A-5E, and 6) for griping belt 217 as belt 217 turns, thereby linearly propelling storage media transport 206. Track 215 may affix to the surface and/or the frame of storage library system 200. Storage media transport 206 may include a camming mechanism that includes cam 203 and camshaft 245. The camming mechanism may adjust the storage media cartridges held by storage media transport 206 to the position adjacent to storage media ports 202.

FIG. 2A illustrates a first position of storage media transport 206 for transferring a storage media cartridge between the access port and storage media transport 206. FIG. 2B illustrates a second position of storage media transport 206 for transferring the storage media cartridge between robotic shuttle 204 and storage media transport 206.

As storage media transport 206 approaches the second position, cam 203 comes into contact with ramp 208 (viewable in FIGS. 5A-5E). Cam 203 may roll across the ramp and adjust the storage media cartridges held in storage media transport 206 to the position adjacent to storage media ports 202. The position may, therefore, be predetermined by a size of ramp 208. Additionally, storage media transport 206 transports the storage media cartridge to the position adjacent to storage media ports 202 while allowing substantially free motion of robotic shuttle 204.

FIG. 3 shows another isometric view illustrating an exemplary preferred embodiment of the invention of storage library system 200. In FIG. 3, storage media ports 202 are removed from the image to better illustrate the second position as discussed in FIGS. 2A and 2B. In FIG. 3, cam 203 is in contact with ramp 208. The contact of cam 203 with ramp 208 may cause camshaft 245 to rotate, thereby adjusting a tray that holds the storage media cartridge within the storage media transport 206. Also more visible in FIG. 3, is gear 205. Gear 205 may connect to belt 217 (viewable in FIGS. 5A-5E and 6); belt 217 is further connected to a gear on driveshaft 216 of motor 230. As with motor 231, motor 230 may be electronically controlled by a microprocessor (not shown) through software instructions. Belt 217 connected to gear 205 and the gear on driveshaft 216 may include “teeth” for gripping the gears and belt clamp 209 to propel storage media transport 206 along track 215 as driveshaft 216 turns. Those skilled in the art understand that other types of belts, gears, and driveshafts may be used. Those skilled in the art understand that pulleys may also be used with or in place of gear 205, belt 217, and driveshaft 216. Those skilled in the art will readily appreciate that other methods of controlling motor 230 may be used.

FIGS. 4A and 4B show isometric views illustrating an exemplary preferred embodiment of storage media transport 206 of storage library system 200. FIGS. 4A and 4B show “open” views of storage media transport 206. The open views are intended to illustrate the mechanical operation of storage media transport 206 in the second position (e.g. when cam 203 contacts ramp 208 in FIG. 2B). In storage library system 200, storage media transport 206 includes storage media cartridge tray 244, camming plates (241, 242, 243, and one not viewable), cam 203, cam shafts 245 and 246, belt clamp 209, and wheels 207. Storage media cartridge tray 244 may form a hinge contact with the camming plates. The camming plates may also form a hinge contact with a carriage. The carriage may have wheels 207 attached to a surface of the carriage. As cam 203 contacts ramp 208, cam 203 rotates, thereby causing cam shaft 245 to rotate. As cam shaft 245 rotates, the camming plates adjust the position of storage media cartridge tray 244 to the position adjacent to storage media ports 202 and away from the carriage. As storage media transport 206 disengages from ramp 208, cam 203 rolls down ramp 208 and rotates cam shaft 245 in an opposite direction, thereby adjusting storage media cartridge tray 244 towards the carriage to a “closed” position.

In storage media cartridge 206, wheels 207 may engage a track, such as track 215 of FIGS. 2A and 2B. The track may guide wheels 207 and, thus, storage media transport 206 between the first and second positions as discussed in FIGS. 2A and 2B. Wheels 207 may be mechanically fastened to the carriage of storage media transport 206 in a variety of manners. For example, wheels 207 may be screwed to the carriage. In storage media cartridge 206, belt clamp 209 is affixed to the carriage for gripping a belt, such as belt 217 shown in FIGS. 5A-5E and 6, connected to motor 230, as discussed in FIGS. 2A and 2B, to transport storage media transport 206 between the first and second positions.

Guide pin 260 is affixed to storage media transport 206 to guide the transport to a secure position by connecting it with plate 220, discussed in FIGS. 5A-5E. For example, plate 220 may have a hole configured in such a way as to provide a guide for guide pin 206 as storage media transport 206 comes into contact with the plate. Those skilled in the art will appreciate that other types of guidance may be configured to provide the secure position for a storage media transport.

FIGS. 5A-5E show views illustrating movement of the exemplary preferred embodiment of robotic shuttle 204 and storage media transport 206 of storage library system 200. FIGS. 5A-5D show four positions of storage media transport 206, respectively referred to as the first-fourth positions hereinafter. In FIG. 5A, storage media transport 206 is in the first position for transferring the storage media cartridge 201 between access port 221 and storage media transport 206. Storage media transport 206 may have a passive latch for retaining the storage media cartridge during transport between the first and fourth positions.

In FIG. 5A, cam 203 is not in contact with ramp 208. Belt 217 may be connected to gear 205 and the gear of driveshaft 216. Storage media transport 206 may contact belt 217 with belt clamp 209 for propelling storage media transport 206 between the first position shown in FIG. 5A and the fourth position shown in FIG. 5D (e.g. the position which adjusts storage media cartridge(s) 201 to the position adjacent to storage media ports 202). Wheels 207 of storage media transport 206 may ride on track 215 to provide substantially fluid motion between the first and fourth positions. In FIG. 5A, storage media transport 206 is in a “closed” position since cam 203 of the camming mechanism is not in contact with ramp 208, as similarly discussed in FIGS. 4A and 4B. While in the fourth position, robotic shuttle 204 may have substantially free access to storage media ports 202 and storage media transport 206. When accessing the storage media cartridge 201, robotic shuttle 204 may grasp the storage media cartridge 201 with robotic gripper 222.

In FIG. 5B, storage media transport 206 is in the second position in which cam 203 makes an initial contact with ramp 208. As cam 203 contacts ramp 208, cam 203 may cause cam shaft 245 (as shown in FIG. 4A) to rotate. Rotation of cam shaft 245 may cause storage media transport tray 244 to adjust storage media cartridge 201 to the position adjacent to storage media ports 202 (e.g. the open views of FIGS. 4A and 4B).

In FIG. 5C, storage media transport 206 is in the third position in which cam 203 makes substantial contact with ramp 208. In FIG. 5C, cam shaft 245 is shown rotating to “open” storage media transport 206.

In FIG. 5D, storage media transport 206 is in the fourth position in which cam 203 makes substantially complete contact with ramp 208. In FIG. 5D, cam shaft 245 has rotated such that storage media transport 206 is in the open position. In FIG. 5D, plate 220 may prevent cam 203 from opening storage media transport 206 beyond a predetermined point so as to improve alignment of storage media transport tray 244. Plate 220 may additionally prevent storage media transport 206 from traveling beyond the fourth position and further provide guidance into a relatively secure position as guide pin 260 (FIG. 4) is guided into a hole of plate 220. While in the fourth position, robotic shuttle 204 may freely access storage media cartridge 201 from either of storage media transport 206 and storage media ports 202.

FIG. 5E illustrates an alternative view of FIG. 5A with storage media transport 206 in the first position. In FIG. 5E, each of wheels 207 rides on track 215 as belt clamp 209 grips belt 217 to propel storage media transport 206 between the first and fourth positions. Thus, a rotation of driveshaft 216 caused by the controllable operation of motor 230 mounted by mounting bracket 213, may propel storage media transport 206 in a first direction to towards the first position. An opposite rotation of driveshaft 216 may propel storage media transport 206 in a second direction to towards the fourth position, thereby causing cam 203 to contact ramp 208 and open storage media transport 206.

FIG. 6, illustrates a view of another exemplary preferred embodiment of a storage media transport in the third position for transferring the storage media cartridge 201 between access port 221 and storage media transport 206. As before, storage media transport 206 may have a passive latch for retaining the storage media cartridge during transport between the first and fourth positions. In this embodiment, the passive latch is part of the transport tray. The transport tray has camming ramp 305 physically attached to the bottom of the tray. Another camming ramp 306 is physically attached to track 215 to cooperatively shift the position of the transport tray when the two ramps come into contact with one another. For example, as storage media transport 206 moves from the first to the fourth position, the ramps 305 and 306 slide against one another to shift the transport tray to the position adjacent to storage media ports 202.

In FIG. 6, camming plate 307 is shown attaching to both storage media transport 206 and the transport tray. Camming plate 307 may serve to control the adjustment of the transport tray towards storage media ports 202. Storage media transport 206 may actually use multiple camming plates that are similar to camming plate 307. Storage media transport 206 may further include a spring mechanism that attaches to the camming plates and the transport to control the adjustment of the transport tray. Those skilled in the art should appreciate that other structures may be used that fall within the scope of the invention.

Guide wheel 304 may be movably attached to the transport tray such that, as the ramps 305 and 306 adjust the position of the transport tray, the guide wheel moves into guide plate 303. The combination of the guide wheel 304 and guide plate 303 may serve a purpose that is similar to that of guide pin 260 and plate 220, discussed above. Together, guide plate 303 and guide wheel 304 may prevent storage media transport 206 from opening the transport tray beyond a predetermined point and improve alignment of the transport tray. As stated previously, while in the fourth position, robotic shuttle 204 may have substantially free access to the storage media cartridges of storage media ports 202 and storage media transport 206.

Those skilled in the art will recognized that the storage media transport may be configured for transporting a plurality of storage media cartridges, such as a magazine of cartridges. As such, the robotic shuttle and each storage media port would be similarly configured to secure multiple storage media cartridges. Thus, the invention is not intended to be limited to the preferred embodiments.

Similarly, the read/write device may be configured in a variety of ways to communicatively access a storage media cartridge and should not be limited to the exemplary preferred embodiments. For example, the read/write device may attach to the robotic shuttle in whole or in parts to communicatively access the storage media cartridges within the robotic shuttle.

In alternative embodiments of the invention, sensors may sense a presence of storage media cartridges at various points within the system. For example, one sensor may detect a presence of a storage media cartridge at the access port, whereas another sensor may detect a presence of the storage media cartridge in the fourth position described in FlGS. 5A-5E. Each sensor may provide a signal which, when processed by a microprocessor, controllably operates motors within the system, such as motors 230 and 231, to operate in accord with the invention. Those skilled in the art understand microprocessors.

Although exemplary embodiments of the invention have been described in detail above, those skilled in the art will readily appreciate that the embodiments may be modified extensively without materially departing from the novel teachings and advantages of the invention. All such modifications fall within the scope of this invention as defined in the following claims.

What is claimed is:

1. A storage library system having a frame and having an access port for operator access to storage media cartridges, including:
a plurality of ports attached to the frame, each of the ports configured for storing at least one of the storage media cartridges;
a robotic shuttle moveably attached to the frame for linearly moving along the plurality of the ports to physically access the plurality of the ports; and
a storage media transport moveably attached to the frame for transporting the storage media cartridges between the access port and a position adjacent to the plurality of the ports, wherein transporting the storage media cartridges includes movement in first and second substantially orthogonal directions.

2. The storage library system of claim 1, further including a read/write device to communicatively access the storage media cartridges.

3. The storage library system of claim 1, wherein the robotic shuttle includes a robotic gripper to manipulate the storage media cartridges between the robotic shuttle and the plurality of the ports.

4. The storage library system of claim 1, wherein the storage media transport includes:
a carriage; and
a transport mechanism for moving the carriage between the access port and the position adjacent to the plurality of the ports while allowing substantially unrestricted motion of the robotic shuttle.

5. The storage library system of claim 4, wherein the carriage includes:
a plurality of wheels; and
a clamp connected to the transport mechanism to enable movement of the carriage.

6. The storage library system of claim 5, wherein the carriage further includes a camming mechanism for adjusting a storage media cartridge transport tray to the position adjacent to the plurality of the ports.

7. The storage library system of claim 6, wherein the transport mechanism includes a ramp attached to the frame for adjusting the position of the storage media cartridge transport tray with the camming mechanism when the camming mechanism contacts the ramp.

8. The storage library system of claim 7, wherein the storage media cartridge transport tray includes a means for securing the transport tray as the transport tray approaches the position adjacent to the plurality of the ports.

9. The storage library system of claim 5, wherein the transport mechanism includes:
a motor having a driveshaft with an attached pulley;
a track configured for guiding the plurality of the wheels; and
a belt system connected to the pulley of the motor for moving the carriage along the track as the driveshaft turns.

10. The storage library system of claim 9, wherein the belt system includes:
a pulley attached to the track such that the belt system wraps around the two pulleys, wherein a turn of the driveshaft actuates motion of the carriage in a direction towards the access port and an opposite turn of the driveshaft actuates motion of the carriage in a direction towards the position adjacent to the plurality of the ports.

11. A method of controllably operating a storage library system to access storage media cartridges that includes steps of:
shuttling at least one of the storage media cartridges between a plurality of ports in a first linear manner; and
transporting the storage media cartridges between an access port and a position adjacent to the plurality of the ports, wherein transporting the storage media cartridges includes movement in first and second substantially orthogonal directions while allowing substantially unrestricted shuttling.

12. The method of claim 11, wherein the step of shuttling includes steps of:
retrieving the storage media cartridges from the plurality of the ports to a read/write device; and
placing the storage media cartridges in the plurality of the ports when ejected from the read/write device.

13. The method of claim 12, wherein the step of shuttling further includes a step of processing one or more signals to initiate the steps of retrieving and placing.

14. The method of claim 12, further including a step of communicatively accessing the storage media cartridges with the read/write device.

15. The method of claim 11, wherein the step of transporting includes steps of:
retrieving the storage media cartridges from the access port; and
ejecting the storage media cartridges through the access port.

16. The method of claim 15, wherein the step of retrieving includes a step of sensing a presence of one or more of the storage media cartridges in the access port.

17. The method of claim 16, wherein the step of retrieving further includes a step of processing a signal to retrieve the storage media cartridges from the access port in response to sensing the presence.

18. The method of claim 15, wherein the step of ejecting includes a step of processing a signal to eject the storage media cartridges through the access port.
